(19) United States
(12) Patent Application Publication
(10) Pub. No.: US 2012/0096869 A1
(43) Pub. Date: Apr. 26, 2012

(54) UTILIZING HEAT DISCARDED FROM A GAS TURBINE ENGINE

(75) Inventors: James B. Kesseli, Greenland, NH (US); William Vandervalk, Biddeford, ME (US); John D. Watson, Evergreen, CO (US)

(73) Assignee: ICR TURBINE ENGINE CORPORATION, Hampton, NH (US)

(21) Appl. No.: 13/281,702

(22) Filed: Oct. 26, 2011

Related U.S. Application Data
(60) Provisional application No. 61/406,823, filed on Oct. 26, 2010.

(51) Int. Cl. F02C 3/20; F02C 7/10

(52) U.S. Cl. 60/772; 60/39.5; 60/39.461

(57) ABSTRACT

Various embodiments are disclosed to utilize various fuels, including liquid natural gas fuels, to improve engine efficiency in gas turbine engines. In one configuration, a fuel is heated by a heat exchanger utilizing waste exhaust heat of a gas turbine engine. In another configuration, LNG fuel is heated using a pre-cooler for the inlet air stream of a gas turbine engine. In another configuration, fuel is injected into the pressurized air, downstream of the air-to-air intercooler. In yet another configuration, fuel is pumped through the engine's intercooler or a secondary heat exchanger exchanging heat with the compressed air stream between the low-pressure compressor and high-pressure compressor. In another configuration, the fuel is first heated by the intercooler and then further heated by a heat exchanger utilizing waste exhaust heat of the gas turbine engine.

### CROSS REFERENCE TO RELATED APPLICATION

The present application claims the benefits, under 35 U.S.C. §119(e), of U.S. Provisional Application Ser. No. 61/406,823 entitled “Intercooler with LNG Vaporizer for a Gas Turbine Engine”, filed Oct. 26, 2010, which is incorporated herein by reference.

### FIELD

The present invention relates generally to gas turbine engine systems and specifically to methods and apparatuses to utilize liquid and gaseous fuels to improve engine efficiency.

### BACKGROUND

There is a growing requirement for alternate fuels for vehicle propulsion. These include fuels such as natural gas, bio-diesel, ethanol, butanol, hydrogen and the like. Means of utilizing fuels needs to be accomplished more efficiently and with substantially lower carbon dioxide emissions and other air pollutants such as NOxs.

The gas turbine or Brayton cycle power plant has demonstrated many attractive features which make it a candidate for advanced vehicular propulsion. Gas turbine engines have the advantage of being highly fuel flexible and fuel tolerant. Additionally, these engines burn fuel at a lower temperature than reciprocating engines so produce substantially less NOxs per mass of fuel burned.

Liquefied natural gas (LNG) is a preferred fueling option for some transportation vehicles, due to its improved storage density, as compared to compressed natural gas (CNG). Insulated LNG tanks contain a 2-phase cryogenic mixture of liquid and vapor in equilibrium. The vapor pressure in the insulated tank varies with ambient temperature, usage, and the fueling intervals. A safety pressure vent is required as the temperature of the mixture warms, and the associated vapor pressure rises to about 250 psia which is the maximum allowable vapor pressure in the transportation sector. One solution is to incorporate a gas compressor or ‘booster’ to control the delivery pressure at the appropriate levels for a high pressure gas turbine engine. This can be a costly solution and results in an additional parasitic energy loss.

There remains a need for innovative ways to manage fuels, and in particular LNG fuels, in ways that can increase gas turbine engine efficiency by utilizing discarded and radiated heat from a gas turbine engine.

### SUMMARY

These and other needs are addressed by the various embodiments and configurations of the present invention which directed generally to gas turbine engine systems and specifically to a method and apparatus to manage various fuels to improve engine efficiency.

In a first configuration, an alternative to the prior art of delivering natural gas vapor from an LNG fuel tank to an engine is to pump LNG from the liquid region of an LNG tank using a cryogenic booster pump. This is a functional solution, however it has two negative consequences: (1) there is a thermodynamic efficiency penalty associated with absorbing heat from the engine's working fluid, prior to combustion; and (2) drawing liquid from the fuel tank does not result in boiling at the liquid-vapor surface. This is because in gas delivery systems, the phase transformation serves to cool the mixture, thereby preventing or delaying the need to vent gas.

In a second configuration, vaporization of LNG fuel is accomplished using a heat exchanger to utilize waste exhaust heat of a gas turbine engine. This configuration provides a thermodynamic benefit to the engine cycle by pre-heating the fuel before injection into the combustor. The use of the hot exhaust gases to pre-heat a fuel stream prior to injection to a combustor can be applied to any gaseous or liquid fuel from those stored at cryogenic temperatures to those stored at room temperature or higher. As long as the fuel is stored at a temperature below the exhaust gas temperature, some pre-heating of the fuel can be obtained.

In a third configuration, vaporization of LNG fuel is accomplished using a pre-cooler for the inlet air stream of a gas turbine engine. The vaporization of the natural gas liquid serves to cool the inlet of low pressure compressor, and hence improves specific power output and engine thermal efficiency.

In a fourth configuration, liquid natural gas is injected into the pressurized air, between two stages of compression. This exploits the beneficial cooling effect as the liquid natural gas flashes into vapor, thereby lowering the high pressure compressor inlet temperature. This results in a fully pre-mixed fuel-air stream at the combustor. Stable combustion may be achieved with a conventional can type combustor or with a lean-burn thermal oxidizer.

In a fifth configuration, LNG is pumped through the engine's intercooler or a secondary heat exchanger exchanging heat with the compressed air stream between the low-pressure compressor and high-pressure compressors. The absorption of heat between the two compressors is thermodynamically beneficial to the cycle and may reduce the size of the conventional intercooler. The use of the hot working fluid exiting the intercooler to pre-heat a fuel stream prior to injection to a combustor can be applied to any gaseous or liquid fuel from those stored at cryogenic temperatures to those stored at room temperature or higher. As long as the fuel is stored at a temperature below the intercooler exit temperature, some pre-heating of the fuel can be obtained.

A variation on the fifth configuration is an optimized combination of smaller intercooler and downstream LNG vaporizer. This provides a significant thermodynamic benefit by cooling the compressed air at the inlet to the high pressure compressor below the temperature otherwise obtainable with a conventional air-to-air intercooler, and simultaneously provides some size reduction of the intercooler.

In a sixth configuration, the fuel is first heated by utilizing waste heat from the intercooler and then further heated by using a heat exchanger to utilize waste exhaust heat of the gas turbine engine. This configuration provides the most overall thermodynamic benefit to the engine cycle. As noted above, this approach can also be used for fuels other than LNG.

In most of the above configurations, LNG is heated beyond ambient temperature by passing it through heat exchangers. The methods that heat LNG beyond ambient temperature can be applied to any fuels which are normally injected at ambient temperature and there will be at least some significant increase in thermal efficiency of the engine.

In one embodiment, an apparatus is disclosed comprising one or more turbo-compressor spools in fluid communication with one another, each of the one or more turbo-compressor spools comprising a compressor in mechanical communication with a turbine; a fuel source comprising a fuel; one of a heat exchanger or heat jacket to transfer heat from a fluid associated with operation of the one or more turbo-compressor spools to a portion of the fuel to substantially heat the portion of the fuel to form a heated fuel; and a combustor operable to combust the heated fuel.

In another embodiment, a method is disclosed comprising compressing, by a compressor in a first turbo-compressor spool, an inlet gas to form a first working fluid; compressing, by a compressor in a second turbo-compressor spool, the first working fluid to form a second working fluid; substantially heating a fuel comprising at least one of liquid natural gas, liquid natural gas vapor, gaseous methane, diesel, kerosene, gasoline, bio-diesel, methanol, ethanol, butanol, ammonia, and hydrogen to form a gas; combusting the fuel and the second working fluid to form a combusted working fluid; driving, by the combusted working fluid, a turbine of the second turbo-compressor spool; and driving, by the combusted working fluid, a turbine of the first turbo-compressor spool.

In yet another embodiment, an apparatus is disclosed comprising at least first and second turbo-compressor spools in fluid communication with one another, each of the at least first and second turbo-compressor spools comprising a compressor in mechanical communication with a turbine; a fuel source comprising at least one of liquid natural gas, liquid natural gas vapor, gaseous methane, diesel, kerosene, gasoline, bio-diesel, methanol, ethanol, butanol, ammonia, and hydrogen; a fuel path to introduce fuel into a working fluid path to substantially heat the fuel to form a gas; and a combustor operable to combust the gas.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.
The following definitions are used herein:

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

CNG Means Compressed Natural Gas.

An energy storage system refers to any apparatus that acquires, stores and distributes mechanical or electrical energy which is produced from another energy source such as a prime energy source, a regenerative braking system, a third rail and a catenary and any external source of electrical energy. Examples are a battery pack, a bank of capacitors, a pumped storage facility, a compressed air storage system, an array of a heat storage blocks, a bank of flywheels or a combination of storage systems.

An engine is a prime mover and refers to any device that uses energy to develop mechanical power, such as motion in some other machine Examples are diesel engines, gas turbine engines, microturbines, Stirling engines and spark ignition engines.

A free power turbine as used herein is a turbine which is driven by a gas flow and whose rotary power drives the principal mechanical output power shaft. A free power turbine is not mechanically connected to a compressor in the gasifier section, although the free power turbine may be in the gasifier section of the gas turbine engine. A power turbine may also be connected to a compressor in the gasifier section in addition to providing rotary power to an output power shaft. This latter configuration is called a turbo-compressor spool.

A heat exchanger as used herein means an apparatus whereby a hot fluid passes through a hot side of the heat exchanger and a cold fluid passes through a cold side of the heat exchanger. The hot fluid and cold fluid are separated by a thermally conductive or thermally radiating barrier and heat energy flows from the hot side to the cold side, thereby heating the colder fluid and cooling the hotter fluid. Examples of thermally conductive heat exchangers are cross-flow and counter flow heat exchangers.

A heat jacket as used herein can be a cross-flow or counter-flow heat exchanger or it can be a jacket that transfers heat by radiative heating. As used herein, a heat jacket may be an annular container surrounding the main flow duct that permits the exchange of heat between the fluid circulating through the heat jacket and the walls of the duct.

An intercooler as used herein means a heat exchanger positioned between the output of a compressor of a gas turbine engine and the input to a higher pressure compressor of a gas turbine engine. Air, or in some configurations, an air-fuel mix is introduced into a gas turbine engine and its pressure is increased by passing through at least one compressor. The working fluid of the gas turbine then passes through the hot side of the intercooler and heat is removed typically by an ambient fluid such as, for example, air or water flowing through the cold side of the intercooler.

LNG means Liquified Natural Gas. Natural gas becomes a liquid when cooled to a temperature of about 111 K or lower at about 1 atmosphere pressure. An LNG “component” refers to a molecular constituent of liquid natural gas regardless of phase.

Natural gas is a gas consisting primarily of methane and typically with about 0-20% higher hydrocarbons (primarily ethane). A natural gas “component” refers to a molecular constituent of natural gas regardless of phase.

A prime power source refers to any device that uses energy to develop mechanical or electrical power, such as motion in some other machine. Examples are diesel engines, gas turbine engines, microturbines, Stirling engines, spark ignition engines and fuel cells.

Power density as used herein is power per unit volume (watts per cubic meter).

A recuperator is a heat exchanger that transfers heat through a network of tubes, a network of ducts or walls of a matrix wherein the flow on the hot side of the heat exchanger is typically exhaust gas and the flow on cold side of the heat exchanger is typically gas (for example, air or a fuel-air mixture) entering the combustion chamber.

Regenerative braking is the same as dynamic braking except the electrical energy generated is recaptured and stored in an energy storage system for future use.

Specific power as used herein is power per unit mass (watts per kilogram).

Spool means a group of turbo machinery components on a common shaft.

A thermal energy storage module is a device that includes either a metallic heat storage element or a ceramic heat storage element with embedded electrically conductive wires. A thermal energy storage module is similar to a heat storage block but is typically smaller in size and energy storage capacity.

A thermal oxidizer is a type of combustor comprised of a matrix material which is typically a ceramic and a large number of channels which are typically circular in cross section. When a fuel-air mixture is passed through the thermal oxidizer, it begins to react as it flows along the channels until it is fully reacted when it exits the thermal oxidizer. A thermal oxidizer is characterized by a smooth combustion process as the flow down the channels is effectively one-dimensional fully developed flow with a marked absence of hot spots.

A thermal reactor, as used herein, is another name for a thermal oxidizer.

A turbine is any machine in which mechanical work is extracted from a moving fluid by expanding the fluid from a higher pressure to a lower pressure.

Turbine Inlet Temperature (TIT) as used herein refers to the gas temperature at the outlet of the combustor which is closely connected to the inlet of the high pressure turbine and these are generally taken to be the same temperature.

A turbo-compressor spool assembly as used herein refers to an assembly typically comprised of an outer case, a radial compressor, a radial turbine wherein the radial compressor and radial turbine are attached to a common shaft. The assembly also includes inlet ducting for the compressor, a compressor rotor, a diffuser for the compressor outlet, a volute for incoming flow to the turbine, a turbine rotor and an outlet diffuser for the turbine. The shaft connecting the compressor and turbine includes a bearing system.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the invention. In the drawings like reference numerals refer to like, or analogous components throughout the several views.

FIG. 1 is a schematic representation of a prior art LNG fuel system.

FIG. 2 is a schematic representation of another prior art LNG fuel system.

FIG. 3 is a schematic representation of yet another prior art LNG fuel system.

FIG. 4 is schematic representation of a prior art LNG fuel tank for injection of LNG fuel vapor in an intercooled recuperated gas turbine engine.

FIG. 5 is schematic representation of a system for injection of liquid LNG fuel directly to the combustion chamber of a gas turbine engine.

FIG. 6 is schematic representation for heating a fuel using waste exhaust heat of a gas turbine engine.

FIG. 7 is schematic representation for heating and vaporization of LNG fuel using a pre-cooler for the inlet air stream of a gas turbine engine.

FIG. 8 is schematic representation for injection of liquid LNG fuel downstream of an intercooler of a gas turbine engine.

FIG. 9 is schematic representation for heating a fuel using an integrated intercooler of a gas turbine engine.

FIGS. 10A and B are schematic comparisons of a base case intercooler with further cooling downstream of the intercooler.

FIGS. 11A and B are schematic comparisons of a base case intercooler with a combination of smaller intercooler and further cooling downstream of the intercooler.

FIGS. 12A and B are schematic comparisons of a base case intercooler with an optimized combination of smaller intercooler and further cooling downstream of the intercooler.

### DETAILED DESCRIPTION

### Baseline Gas Turbine Engine Performance and Enthalpy to Heat Fuel

In the following examples of fuel delivery strategies, a baseline intercooled, recuperated, multi-spool gas turbine engine operating on methane fuel is used to illustrate the effect on engine efficiency and output power. The following also includes the enthalpy and power to raise either liquid or vapor methane fuels to various temperatures suitable for fuel injection.

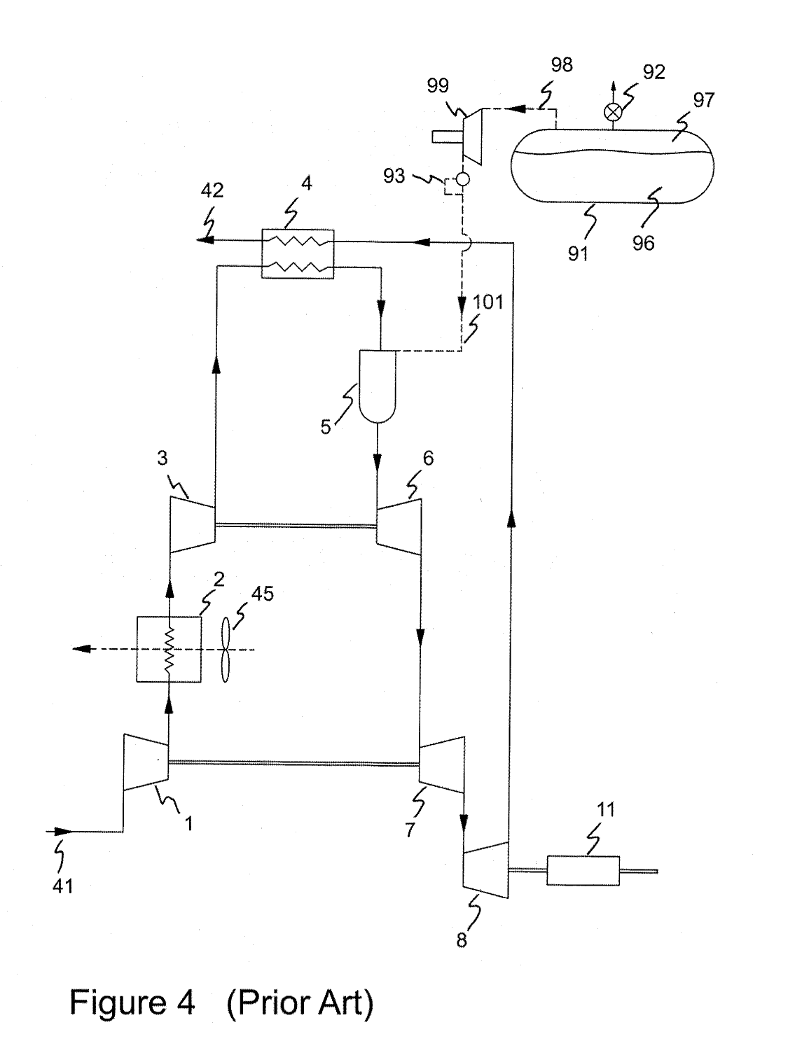

As an example, consider the performance of an intercooled and recuperated gas turbine engine, such as shown in FIG. 4. With reference to Table I, the computed baseline engine inputs and outputs at full power are as follows:

TABLE I

| Fuel | methane |
|---|---|
| Shaft Power Out at Full Power (kW) | 377 |
| Thermal Efficiency (%) | 43.18 |
| Turbine Inlet Temperature (K) | 1,366 |
| Turbine Inlet Pressure (Pa) | 1,412,088 |
| Inlet Air Flow Rate (kg/s) | 1.172 |
| Fuel-Air Ratio | 0.0149 |
| Fuel Flow Rate (kg/s) | 0.01746 |

The computed pressures and temperatures at full power are shown in Table II for various locations in the thermodynamic cycle.

TABLE II

| | p (Pa) | T (K) |
|---|---|---|
| Ambient Air In | 101,379 | 288.15 |
| Output Low Pressure Compressor | 302,552 | 424.5 |
| Output Intercooler | 296,501 | 292.0 |
| Output High Pressure Compressor | 1,482,414 | 500.1 |
| Output Recuperator Cold Side | 1,452,766 | 779.2 |
| Output Combustor | 1,412,088 | 1,366.5 |
| Output High Pressure Turbine | 702,408 | 1,194.6 |
| Output Low Pressure Turbine | 427,134 | 1,080.4 |
| Output Free Power Turbine | 104,739 | 809.9 |
| Output Recuperator Hot Side | 101,886 | 546.4 |
| Exhaust Gases Out | 101,379 | 546.4 |

The above data is computed for methane fuel injected at ambient temperature (˜298 K).

The following tables show the specific enthalpy and equivalent power required by the above engine to heat methane fuel from its storage temperature to room temperature (˜298 K), intercooler outlet temperature (˜410 K) and to near combustor inlet temperature (˜700 and ˜745 K).

TABLE III
LNG Stored at 100 K
Methane Fuel Flow Rate = 0.1746 kg/s

| T (K) | Enthalpy (J/kg) | Power (kW) |
|---|---|---|
| 298 | 946,315 | 16.52 |
| 410 | 1,213,361 | 21.19 |
| 700 | 2,112,941 | 36.89 |
| 745 | 2,279,631 | 39.80 |

For LNG stored at 100 K, the power required to heat the fuel to room temperature is about 16.5 kW. The power required to heat the fuel from 100 K to near combustor inlet temperature (˜745 K) is almost 40 kW.

TABLE IV
LNG Vapor Stored at 100 K
Methane Fuel Flow Rate = 0.1746 kg/s

| T (K) | Enthalpy (J/kg) | Power (kW) |
|---|---|---|
| 298 | 417,698 | 7.29 |
| 410 | 684,744 | 11.96 |
| 700 | 1,584,324 | 27.66 |
| 745 | 1,751,014 | 30.57 |

For methane vapor at 100 K, the power required to heat the fuel to room temperature is about 7.3 kW. The power required to heat the fuel from 100 K to near combustor inlet temperature (˜745 K) is almost 31 kW.

TABLE V
CNG Stored at 298 K
Methane Fuel Flow Rate = 0.1746 kg/s

| T (K) | Enthalpy (J/kg) | Power (kW) |
|---|---|---|
| 298 | 0 | 0 |
| 410 | 267,046 | 4.66 |
| 700 | 1,166,626 | 20.37 |
| 745 | 1,333,316 | 23.28 |

For methane stored at room temperature (about 298 K), the power required to heat the fuel to near combustor inlet temperature (˜745 K) is almost 24 kW.

The above power estimates are appropriate if an external means are used to heat the fuel. As will be discussed below, a much better approach is to heat fuel using waste heat from the engine (primarily heat discarded by the intercooler and/or the exhaust) rather than to use auxiliary power from the engine's output.

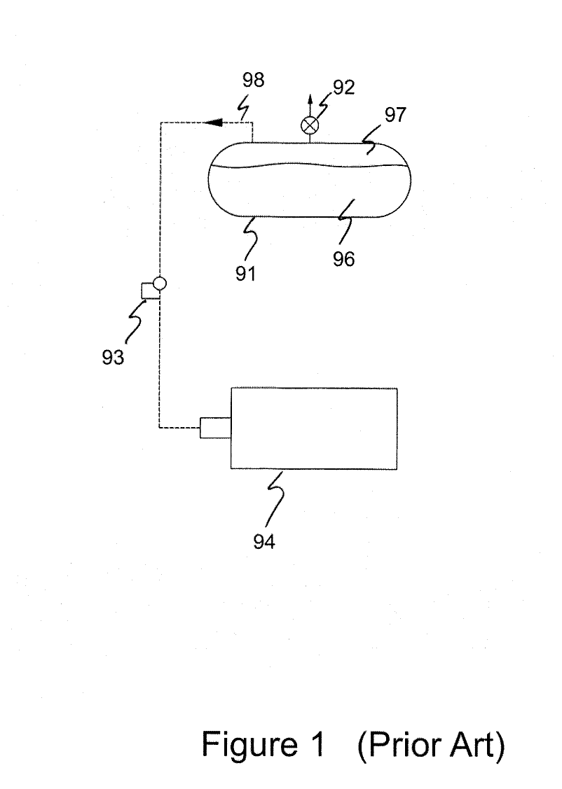

FIG. 1 is a schematic representation of a prior art LNG fuel system. This is an example of a naturally aspirated natural gas engine 94 where pressurized natural gas vapor 97 is bled off through a valve from LNG tank 91 and controlled by gas pressure regulator 93. Natural gas vapor is introduced into engine 94 as shown by the dotted line path 98 from tank 91 through gas pressure regulator 93 to engine 94. LNG tank 91 contains liquid natural gas 96 and natural gas vapor 97 and includes a safety pressure vent valve 92.

As will be appreciated, the components in the LNG fuel tank 91 are substantially in the liquid phase. Commonly, at least about 75 mole %, more commonly at least about 85 mole %, and even more commonly at least about 95 mole % of the components are in the liquid phase, with the balance being in the gas phase.

As used herein, “substantially vaporized” refers to natural gas or LNG components being primarily in a liquid state before vaporization and substantially in a vapor state after vaporization. For example, the LNG components in a typical LNG stream upstream of vaporization is at least about 75 mole %, more typically at least about 85 mole %, and even more typically at least about 95 mole % liquid while the natural gas components in a typical vaporized natural gas stream is at least about 75 mole %, more typically at least about 85 mole %, and even more typically at least about 95 mole % vapor.

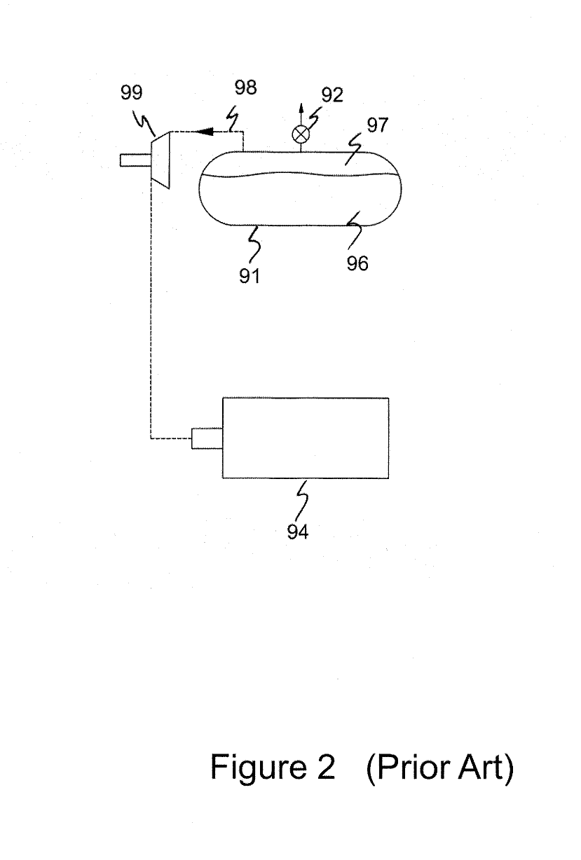

FIG. 2 is a schematic representation of another prior art LNG fuel system. High pressure fuel vapor is injected into a natural gas engine 94. Pressurized natural gas 97 is pumped with gas booster pump 99 through a valve from LNG tank 91 to engine 94. Natural gas vapor is introduced into engine 94 as shown by the dotted line path 98 from tank 91 through booster pump 99 to engine 94. LNG tank 91 contains liquid natural gas 96 and natural gas vapor 97 and includes a safety pressure vent valve 92.

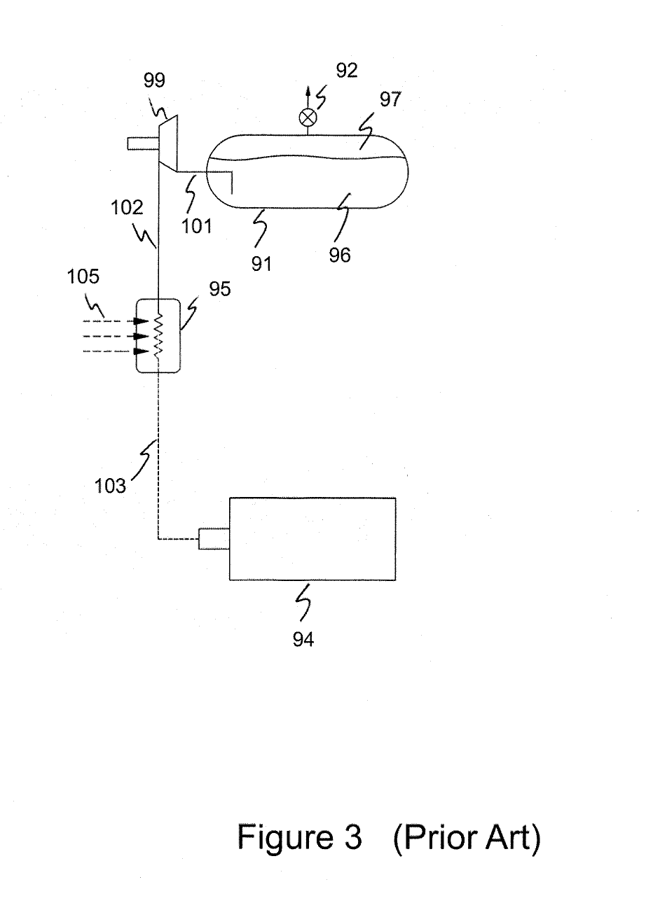

FIG. 3 is a schematic representation of yet another prior art LNG fuel system where high pressure fuel vapor is injected into natural gas engine 94. Liquid natural gas 96 is pumped from LNG tank 91 and sent through a vaporizer 95 where the liquid natural gas is substantially vaporized. Natural gas vapor is introduced into engine 94 as shown first by liquid path 101 connecting LNG tank 91 with a liquid fuel pump 99 and then by liquid path 102 connecting liquid fuel pump 99 and vaporizer 95. The liquid is substantially vaporized in vaporizer 95 by heat input 105 and continues down vapor path 103 denoted by a dotted line to engine 94. LNG tank 91 contains mainly liquid natural gas 96 and natural gas vapor 97 and includes a safety pressure vent valve 92.

FIG. 4 is schematic representation of a prior art LNG fuel tank for injection of LNG fuel vapor into an intercooled, recuperated gas turbine engine. The gas turbine's working fluid gas (typically air) is ingested at inlet 41 into, a low pressure compressor 1. The outlet of the low pressure compressor 1 passes through an intercooler 2 which removes a portion of heat from the gas stream at approximately constant pressure. The intercooler is shown with a fan 45 that blows ambient fluid, such as air or water for example, across the intercooler. Both cross-flow and counter-flow intercooler configurations may be used. The working gas then enters a high pressure compressor 3. The outlet of high pressure compressor 3 passes through a recuperator 4 where some heat from the exhaust gas is transferred, at approximately constant pressure, to the gas flow from the high pressure compressor 3. The further heated gas from recuperator 4 is then directed to a combustor 5 where a fuel is burned, adding heat energy to the gas flow at approximately constant pressure. The gas emerging from the combustor 5 then enters a high pressure turbine 6 where work is done by the turbine to operate the high pressure compressor 3. The gas from the high pressure turbine 6 then drives a low pressure turbine 7 where work is done by the turbine to operate the low pressure compressor 1. The gas from the low pressure turbine 7 then drives a free power turbine 8. The working fluid exiting the free power turbine 8 then flows through the hot side of recuperator 4 giving up some of its heat energy to the gas flowing through the cold side of recuperator 4. The flow exiting the hot side of recuperator 4 then is exhausted to the atmosphere at outlet 42 which is commonly called the exhaust pipe. In this illustration, the shaft of the free power turbine, in turn, drives a transmission 11 which may be an electrical, mechanical or hybrid transmission for a vehicle. Alternately, the shaft of the free power turbine can drive an electrical generator or alternator. This engine design is described, for example, in U.S. patent application Ser. No. 12/115,134 filed May 5, 2008, entitled “Multi-Spool Intercooled Recuperated Gas Turbine”, which is incorporated herein by this reference.

This figure also shows an LNG fuel tank 91 and fuel injection equipment. Pressurized natural gas vapor is introduced into combustor 5 as shown by path 98 from tank 91 through booster pump 99 and gas pressure regulator 93 and thence by path 101 to combustor 5. LNG tank 91 contains liquid natural gas 96 and natural gas vapor 97 and includes a safety pressure vent valve 92. A gas turbine may operate on the vapor or gaseous phase residing in fuel tank 91, however this pressure is highly variable. A high fueling rate lowers the tank temperature and pressure, often to a pressure below the desired operating level of the gas turbine engine. A gas compressor 99 can boost and stabilize the combustor delivery pressure, but cryogenic gas compressors are expensive and have high maintenance.

In the baseline engine performance calculation, summarized above, the fuel supply is assumed to be injected at room temperature. In the configuration of FIG. 4, the methane vapor is stored and injected at approximately 100 K and it would require an approximate enthalpy change of about 418,000 J/kg to bring the vapor up to about room temperature. For a nominal fuel flow rate of 0.01746 kg/s, this requires auxiliary power of about 7.3 kW to heat the methane vapor to about room temperature.

It is estimated that injecting methane vapor at 100 K directly into the combustor would reduce engine efficiency from its baseline efficiency of about 43.2% (fuel injected at 298 K) to about 42.8%.

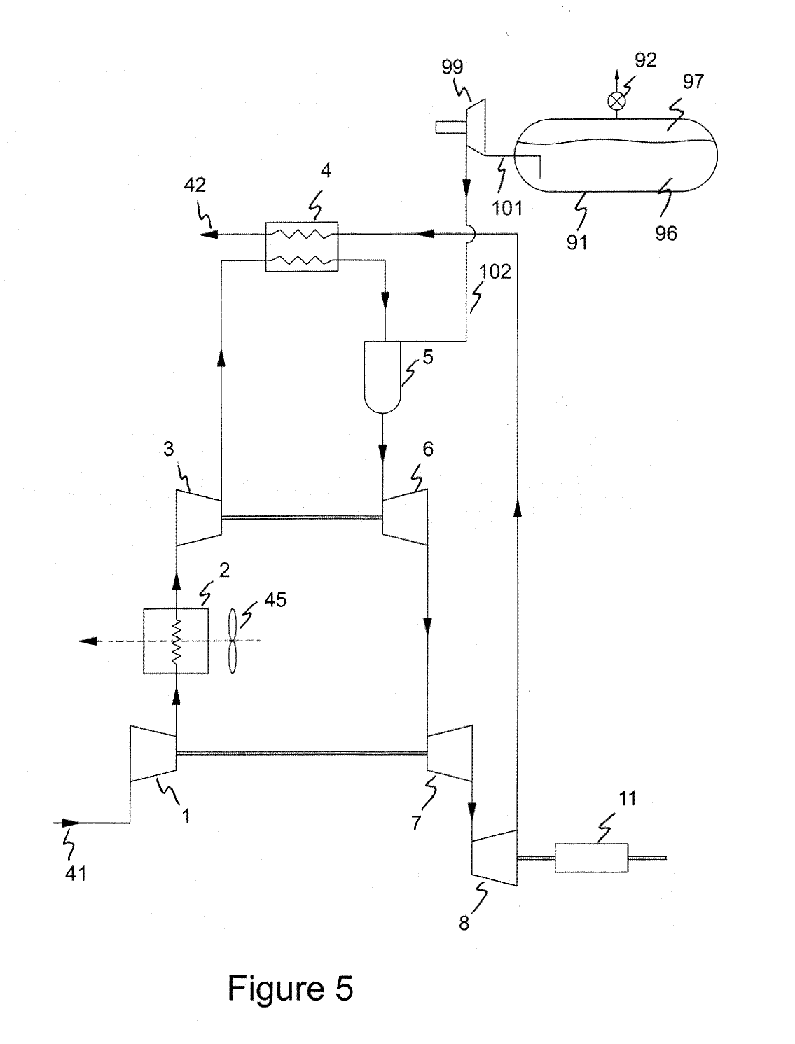

FIG. 5 is schematic representation of a system for injection of liquid LNG fuel in an intercooled recuperated gas turbine engine. An alternative to delivering gas to the engine is to pump liquid natural gas from the liquid region of tank 91. This is a functional solution, however it has two negative consequences: (1) there is a thermodynamic efficiency penalty associated with using heat from the engine's working fluid to substantially vaporize and heat the fuel to combustion temperature; and (2) drawing liquid from the tank directly does not result in boiling at the liquid-vapor surface. In gas delivery systems (such as shown in FIGS. 1 and 2), the phase transformation from boiling serves to cool the mixture, thereby preventing or delaying the need to vent gas. This figure shows the same engine components as described in FIG. 4 but with the addition of an LNG fuel tank 91 and fuel injection equipment. Liquid natural gas 96 is pumped with a cryogenic booster pump 99 through a valve from LNG tank 91 to combustor 5. Liquid natural gas is introduced into combustor 5 as shown by path 101 from tank 91 through booster pump 99 and thence by path 101 to combustor 5. LNG tank 91 contains mainly liquid natural gas 96 and natural gas vapor 97 and includes a safety pressure vent valve 92.

In the configuration of FIG. 5, the LNG is assumed to be stored at approximately 100 K and it would require an approximate enthalpy change of about 946,000 J/kg to bring the liquid up to a vapor at about room temperature. For a nominal fuel flow rate of 0.01746 kg/s, this requires auxiliary power of about 16.5 kW to heat the LNG to about room temperature.

It is estimated that injecting liquid methane at 100 K directly into the combustor would reduce engine efficiency from its baseline efficiency of about 43.2% (fuel injected at 298 K) to about 42.4%.

If the LNG were to be heated to about 700 K by a heat exchanger that can utilize the energy of the hot exhaust gases, the increase in overall thermal efficiency of the engine would be about 1%. No auxiliary power would be required to heat the LNG fuel and the full power output of 377 kW can be utilized for the engine application.

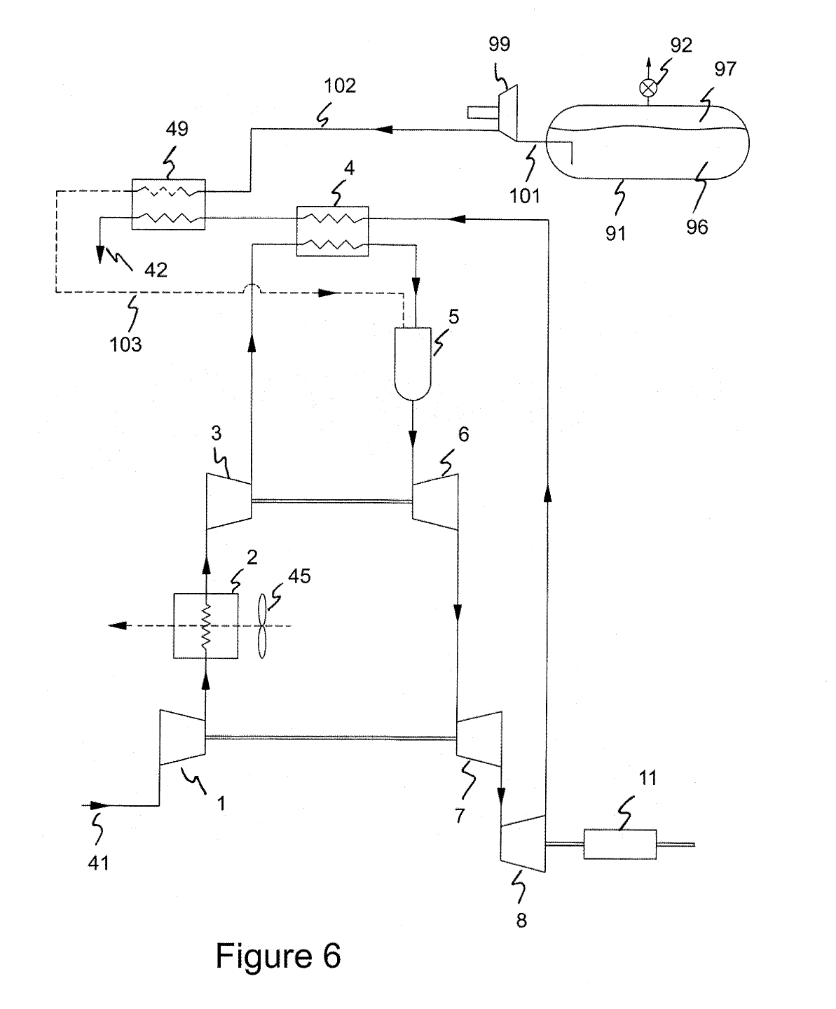

FIG. 6 is schematic representation for heating a fuel using the exhaust heat energy of a gas turbine engine to transform the liquid to gas phase and further heat the fuel. This solution provides a thermodynamic benefit to the engine cycle by using otherwise waste heat to help raise the temperature of the fuel to a level where the energy required to bring the fuel to injection temperature is minimized. This figure shows the same engine components as described in FIG. 4 but with the addition of an exhaust heat exchanger 49. Liquid natural gas 96 is pumped with a cryogenic booster pump 99 through a valve from LNG tank 91 to heat exchanger 49 where it is substantially vaporized. The resulting natural gas vapor is then injected into combustor 5. Liquid natural gas is pumped as shown by path 101 from tank 91 through booster pump 99, from booster pump 99 as a liquid to the cold side of heat exchanger 49 via path 102 and from heat exchanger 49 to combustor 5 as a gas via path 103. Hot engine exhaust gases from the hot side of recuperator 4 are directed through the hot side of heat exchanger 49 where thermal energy is transferred to the cold side of heat exchanger 49 to substantially vaporize the LNG fuel stream. LNG tank 91 contains mainly liquid natural gas 96 and natural gas vapor 97 and includes a safety pressure vent valve 92.

In the configuration of FIG. 6, the LNG is assumed to be stored at approximately 100 K and it would require an approximate enthalpy change of about 946,000 J/kg to bring the liquid up to a vapor at about room temperature. For a nominal fuel flow rate of 0.01746 kg/s, this could require auxiliary power of about 16.5 kW to heat the LNG to about room temperature.

If the LNG is heated by a heat exchanger using the heat of the exhaust gases such as illustrated in FIG. 6, then a practical sized heat exchanger can be used to deliver methane vapor to the combustor at about 700 K. This would increase the overall thermal efficiency of the engine by about 1% from about 43.2% to about 44.2%. No auxiliary power would be required to heat the LNG fuel and the full power output of 377 kW can be utilized for the engine application.

The use of the hot exhaust gases to heat a fuel stream prior to injection to a combustor can be applied to any gaseous or liquid fuel from those stored at cryogenic temperatures to those stored at room temperature or higher. As long as the fuel is stored at a temperature below the exhaust gas temperature, some pre-heating of the fuel and some increase in thermal efficiency of the engine can be obtained.

The heat exchanger to capture heat from the exhaust gases may be a heat jacket around a section of the exhaust pipe. A simple heat jacket is practical because the mass of cold fluid (fuel) is small compared to the mass of hot fluid (combustion products). In the above examples the mass of fuel is typically about 18 grams and the mass of combustion products is about 1.2 kg.

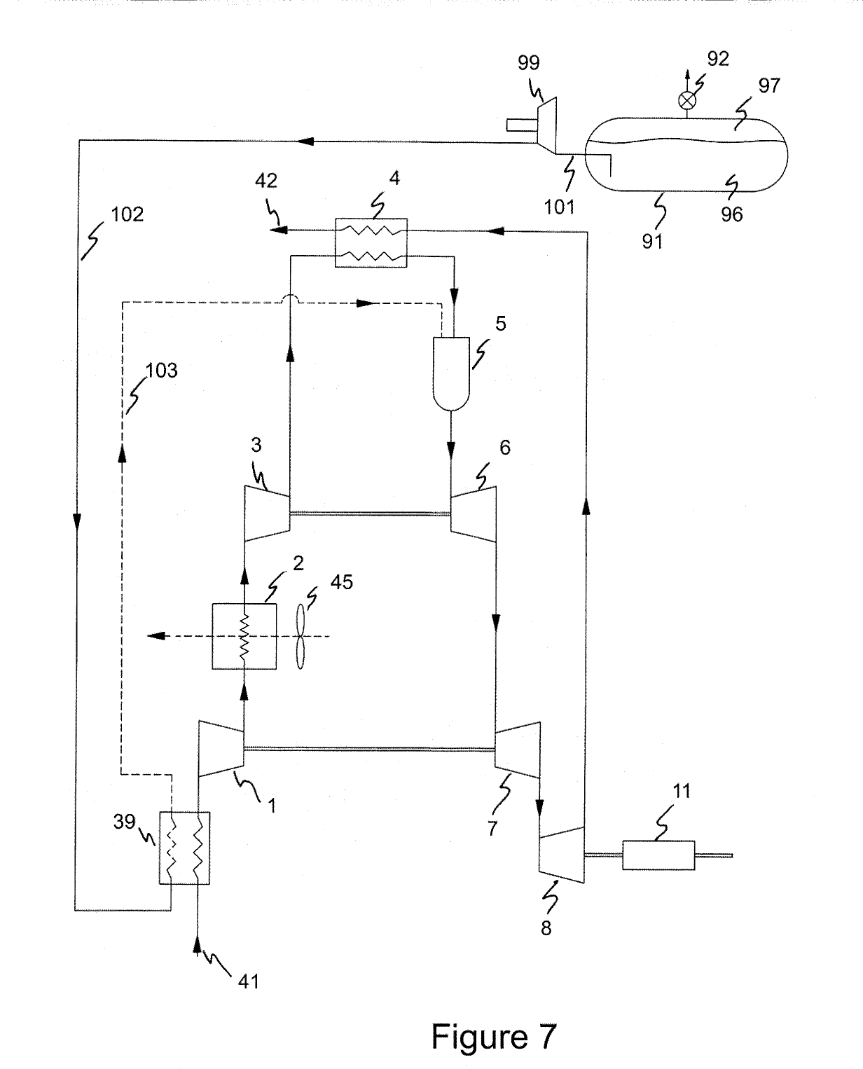

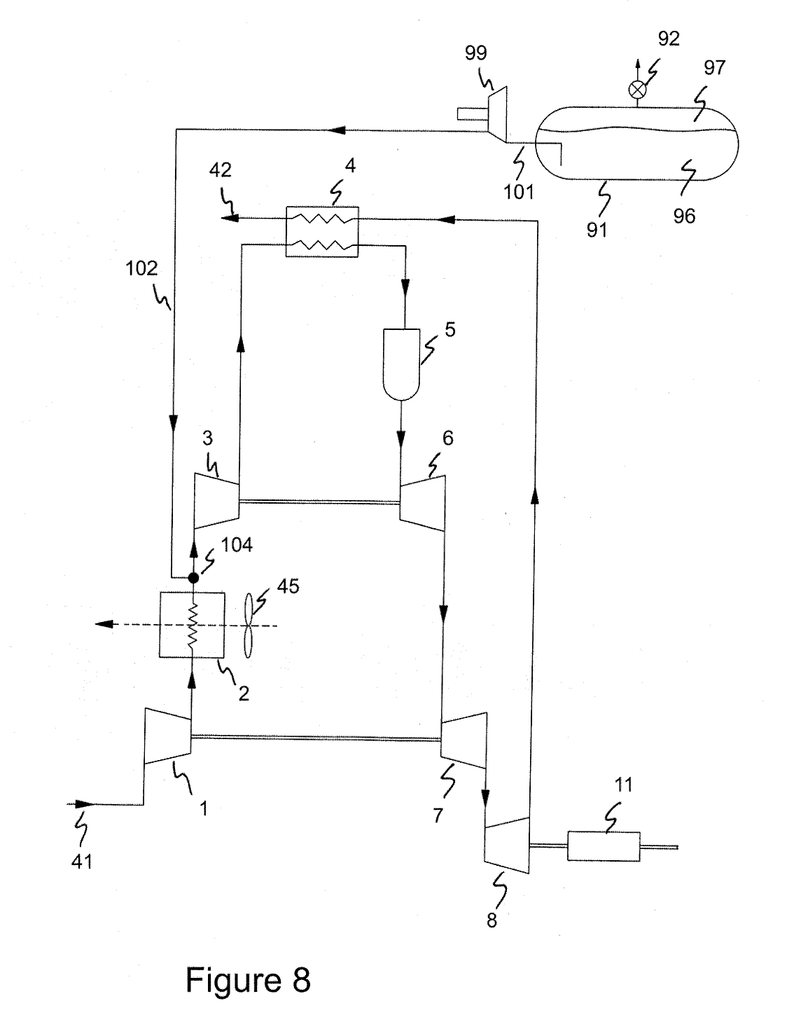

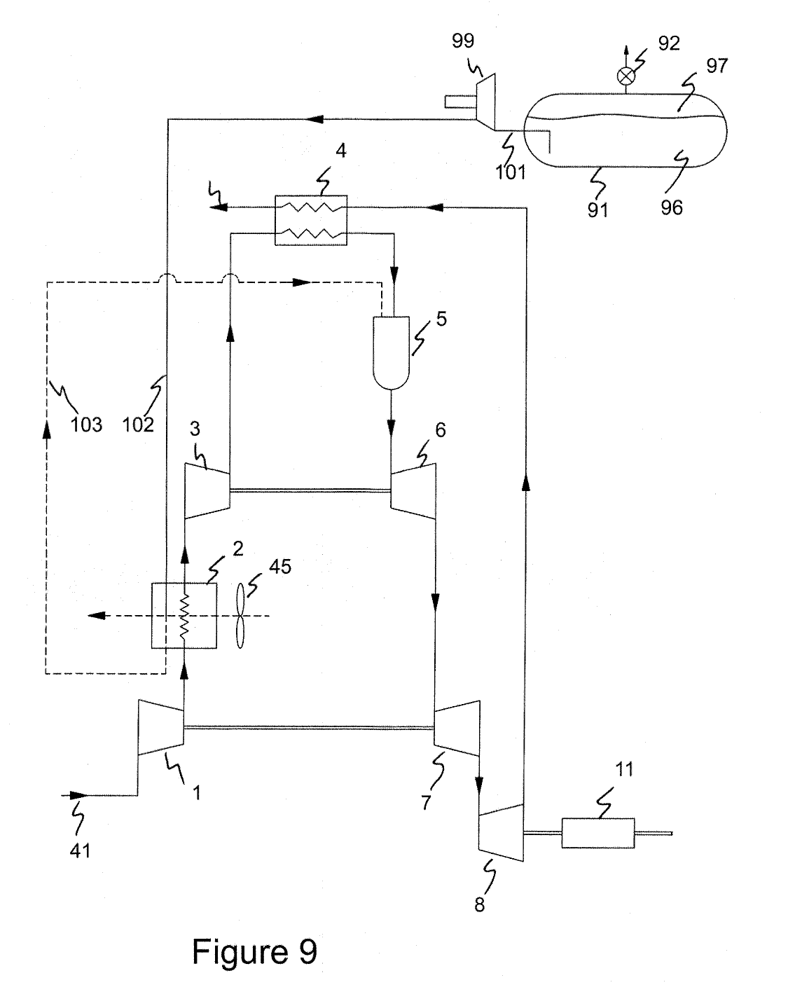

FIG. 7 is schematic representation for vaporization of LNG fuel using a pre-cooler 39 for the inlet air stream 41 of a gas turbine engine. The vaporization of the natural gas liquid serves to cool the inlet of low pressure compressor 1, and hence improves specific power and efficiency. This configuration for utilizing LNG for cooling the air flow is more preferable than the configuration of FIG. 5 but less preferable than the configurations illustrated in FIGS. 8 and 9. This figure shows the same engine components as described in FIG. 4 but with the addition of an inlet heat exchanger 39. Liquid natural gas 96 is pumped from the LNG fuel tank by a cryogenic booster pump 99 through a valve from LNG tank 91 to pre-cooler 39 where it is substantially vaporized. The resulting natural gas vapor is then injected into combustor 5. Liquid natural gas is pumped as a liquid as shown by path 101 from LNG fuel tank 91 by cryogenic booster pump 99 through a valve to pre-cooler via path 102 and from pre-cooler 39 to combustor 5 as a gas via path 103. LNG tank 91 contains mainly liquid natural gas 96 and natural gas vapor 97 and includes a safety pressure vent valve 92.

In the configuration of FIG. 7, the LNG is assumed to be stored at approximately 100 K and it would require an approximate enthalpy change of about 946,000 J/kg to bring the liquid up to a vapor at about room temperature. For a nominal fuel flow rate of 0.01746 kg/s, this requires auxiliary power of about 16.5 kW to heat the LNG to about room temperature. If the LNG is heated by a heat exchanger using the inlet air such as illustrated in FIG. 7, then a practical sized heat exchanger can be used to deliver methane vapor at about 280 K. There is an increase in efficiency of the engine cycle because of the lower temperature inlet air (lowered from about 288 K to about 280 K). This increase in engine thermal efficiency is estimated to be about 0.5% where the inlet mass flow is adjusted slightly downwards to maintain nominal baseline full output shaft power of 377 kW.

The heat exchanger to capture heat from the inlet air may be a heat jacket around a section of the inlet air duct. A simple heat jacket is practical because the mass of cold fluid (fuel) is small compared to the mass of hot fluid (inlet air). In the above examples the mass of fuel is typically about 18 grams and the mass of inlet air is about 1.2 kg.

FIG. 8 is schematic representation for injection of liquid LNG fuel downstream of an intercooler of a gas turbine engine. The liquid natural gas is injected into the pressurized air, downstream of the normal air-to-air intercooler. This exploits the beneficial cooling effect as the liquid natural gas flashes substantially into vapor, thereby lowering the high pressure compressor inlet temperature. This results in a fully pre-mixed fuel-air stream at the combustor. Stable combustion may be achieved with a conventional can type combustor or with very lean-burn thermal oxidizer. This is a preferred embodiment in the event that a ultra-lean burn thermal oxidizer is employed. It is noted that liquid pump 99 may also be eliminated, since the pressure at the high pressure compressor inlet is below the minimum pressure of the vessel. This figure shows the same engine components as described in FIG. 4 but with fuel injected just upstream of the second stage compressor rather than into the combustor. Liquid natural gas 96 is pumped with a cryogenic booster pump 99 through a valve from LNG tank 91 and is injected as a liquid directly into the main airstream between intercooler 2 and high pressure compressor 3 at point 104. Liquid natural gas is pumped as shown by path 101 from tank 91 through booster pump 99, from booster pump 99 along path 102 as a liquid to injection point 104 where the liquid natural gas flashes into vapor as it enters the air stream. LNG tank 91 contains mainly liquid natural gas 96 and natural gas vapor 97 and includes a safety pressure vent valve 92.

It is estimated that this approach will increase efficiency of the engine cycle by about 0.5% because of the lower temperature of the air entering the second stage compressor even though the air stream would have to provide the enthalpy to raise the LNG to local temperature.

FIG. 9 is schematic representation for heating a fuel using an integrated intercooler of a gas turbine engine. In this configuration, liquid natural gas 96 is pumped through an intercooler 2 or a secondary heat exchanger exchanging heat with the compressed air stream between the low-pressure compressor 1 and high-pressure compressor 3. The absorption of heat between the two compressors is thermodynamically beneficial to the cycle and may reduce the size of the conventional intercooler. Furthermore, it is often preferable to deliver fuel in its gas phase to the combustor rather than in its liquid phase. Even furthermore, the low pressure compressor 1 discharge temperature is a favorable temperature to serve as a vaporizer—not too hot, thus simplifying controls. This figure shows the same engine components as described in FIG. 4 but with the addition of a modified intercooler in the path of the fuel stream. Liquid natural gas 96 is pumped with a cryogenic booster pump 99 through a valve from LNG tank 91 to intercooler 2 where it is substantially vaporized. The resulting natural gas vapor is then injected into combustor 5. Thus liquid natural gas is substantially vaporized by intercooler 2 and introduced into combustor 5. Liquid natural gas is pumped as shown by path 101 from tank 91 through booster pump 99, from booster pump 99 as a liquid to intercooler 2 via path 102 and from intercooler 2 to combustor 5 as a gas via path 103. LNG tank 91 contains mainly liquid natural gas 96 and natural gas vapor 97 and includes a safety pressure vent valve 92.

It is estimated that when LNG fuel is used to enhance cooling, the intercooler exit temperature can be lowered by about 21 degrees F. as compared to the non-enhanced intercooler. The effect of additional pre-cooling of the main air flow at the inlet of the high pressure compressor by about 21 F, as estimated using a gas turbine simulation program, shows that engine efficiency is increased by just over about 1.2% to about 44.4% when the input air flow is slightly reduced to maintain output shaft power at 377 kW. In this estimate, there is some heating of the fuel beyond ambient temperature of about 298 K to about 410 K.

### Combining an Intercooler and an Exhaust Heat Exchanger.

If the LNG fuel is passed thru an intercooler vaporizer such as shown in FIG. 9 and then through an exhaust heat exchanger such as shown in FIG. 6, the fuel can be heated to approximately 745 K which is about 35 K cooler than the output of the hot side of the recuperator. In this case there is an increase in thermal efficiency of about 2.15% over the full power thermal efficiency of the baseline engine performance. The efficiency of this configuration is estimated to be about 45.3% (compared to baseline efficiency of 43.18%) when the input air flow is slightly reduced to maintain output shaft power at 377 kW. In this configuration, there is no power penalty for heating LNG to room temperature. There is a thermodynamic advantage from cooling the outlet air from the intercooler and a further thermodynamic advantage from heating the fuel from ambient temperature to nearly the output temperature of the hot side of the recuperator. To gain these advantages, an exhaust heat exchanger is required and a modified intercooler system (as described below) is required. These are not large heat exchangers as the mass of cold fluid (fuel) is small compared to the mass of hot fluid (air or combustion products). In the above examples the mass of fuel is typically about 18 grams and the mass of inlet air or combustion products is about 1.2 kg.

### Summary of Thermal Efficiencies for Various Fuel Injection Strategies

The engine efficiency estimates in Table VI are based on the low heat value for methane and are the engine efficiencies based on shaft power output of the free power turbine. As can be appreciated, these are computed values and are representative of the level of performance gain or loss from the various fuel injection strategies for the 377 kW engine used to illustrate the various strategies.

TABLE VI
Methane Fuel Output Power 377 kW

| | | Change |
|---|---|---|
| | Engine | from |
| Fuel Injection Case | Efficiency | Baseline |
| Baseline - Injection at 298 K | 43.18% | |
| Direct Injection of LNG Vapor at 100 K | 42.82% | −0.36% |
| Direct Injection of LNG Liquid at 100 K | 42.38% | −0.80% |
| Exhaust Heat Exchanger | 44.16% | +0.98% |
| Injection of LNG Liquid at 100 K after Intercooler | est ~43.6% | ~+0.4% |
| Inlet Heat Exchanger | 43.70% | +0.52% |
| Intercooler Heat Exchanger | 44.43% | +1.25% |
| Intercooler and Exhaust Heat Exchangers | 45.33% | +2.15% |

### Intercooler Heat Exchangers

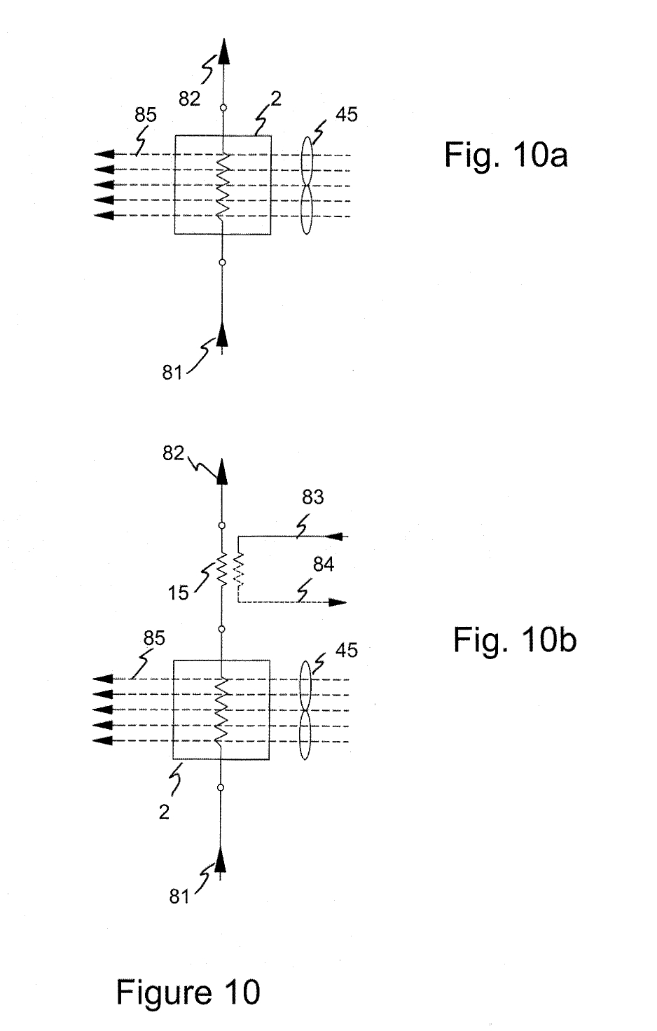

FIG. 10 is a schematic comparison of a base case intercooler in FIG. 10a with a separate fuel vaporizer for additional cooling downstream of intercooler 2 in FIG. 10b. The case illustrated in FIG. 10b exploits the cooling potential of vaporizing liquid natural gas to reduce high pressure compressor inlet temperature.

FIG. 10a illustrates a standard cross flow air-to-air intercooler which is the base case used to illustrate improvements using LNG cooling in subsequent configurations. In the present example, the inlet air 81 to intercooler 2 enters at typically about 416 K (˜290 F). The cross flow cooling air 85 driven by fan 45 enters intercooler 2 typically at about 288 K (˜59 F). The outlet air 82 from intercooler 2, with a typical cross flow heat exchanger, is typically at about 292 K (˜66 F). The heat exchange process occurs at approximately constant pressure. The effectiveness of the base case intercooler is about 0.9182.

In FIG. 10b, the same intercooler 2 is used as in FIG. 10a but a fuel vaporizer 15 is added downstream of intercooler 2. In this case, the inlet air 81 to intercooler 2 enters at typically about 416 K (˜290 F). The cross flow cooling air 85 driven by fan 45 enters typically at about 298 K (˜59 F). The outlet air 82 from intercooler 2 is typically at about 292 K (˜66 F). The main air flow is further cooled by fuel vaporizer 15 to 281 K (˜45 F) by the liquid natural gas stream 83 which enters fuel vaporizer 15 at a temperature in the range of about 130 K to about 150 K and exits fuel vaporizer 15 as a vapor at a temperature of about 290 K (˜63 F). This vapor can then be injected into the engine's combustor (not shown). Both intercooler and fuel vaporizer processes occur at approximately constant pressure. The effectiveness of the base case intercooler is about 0.9182.

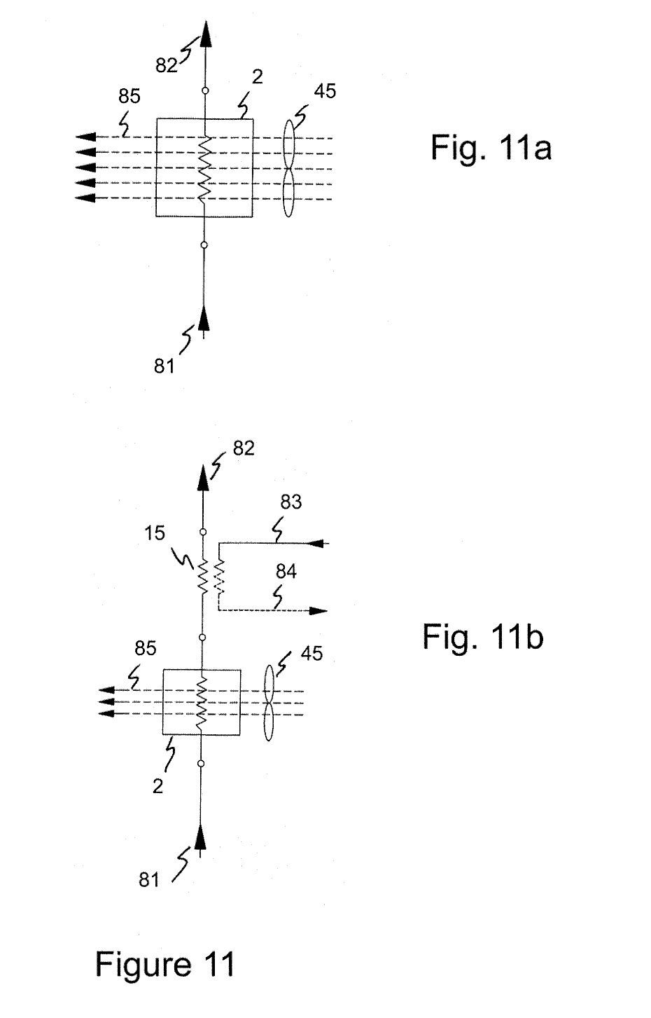

FIG. 11 is a schematic comparison of a base case intercooler with a combination of a smaller intercooler and a separate fuel vaporizer for additional cooling downstream of the intercooler. This schematic and accompanying analysis demonstrate how the cooling potential of the vaporizing liquid natural gas can reduce the size of the intercooler.

FIG. 11a illustrates a standard cross flow air-to-air intercooler which is the base case used to illustrate improvements using LNG cooling in subsequent configurations. In the present example, the inlet air 81 to intercooler 2 enters at typically about 416 K (˜290 F). The cross flow cooling air 85 driven by fan 45 enters intercooler 2 typically at about 298 K (˜59 F). The outlet air 82 from intercooler 2, as in FIG. 10a, is typically at a temperature of about 292 K (˜66 F). The heat exchange process occurs at approximately constant pressure.

In FIG. 11b, a smaller intercooler 2 is used along with a fuel vaporizer 15 which is located downstream of intercooler 2. In this case, the inlet air 81 to intercooler 2 enters at typically about 416 K (˜290 F). The cross flow cooling air 85 driven by fan 45 enters typically at about 298 K (˜59 F). The outlet air 82 from smaller intercooler 2 is typically at about 303 K (˜86 F). The main air flow is further cooled by fuel vaporizer 15 to 292 K (˜66 F) by the liquid natural gas stream 83 which enters fuel vaporizer 15 at a temperature in the range of about 130 K to about 150 K and exits fuel vaporizer 15 as a vapor at a temperature of about 290 K (˜63 F). This vapor can then be injected into the engine's combustor (not shown). Both intercooler and fuel vaporizer processes occur at approximately constant pressure. The effectiveness of the base case intercooler is about 0.8792.

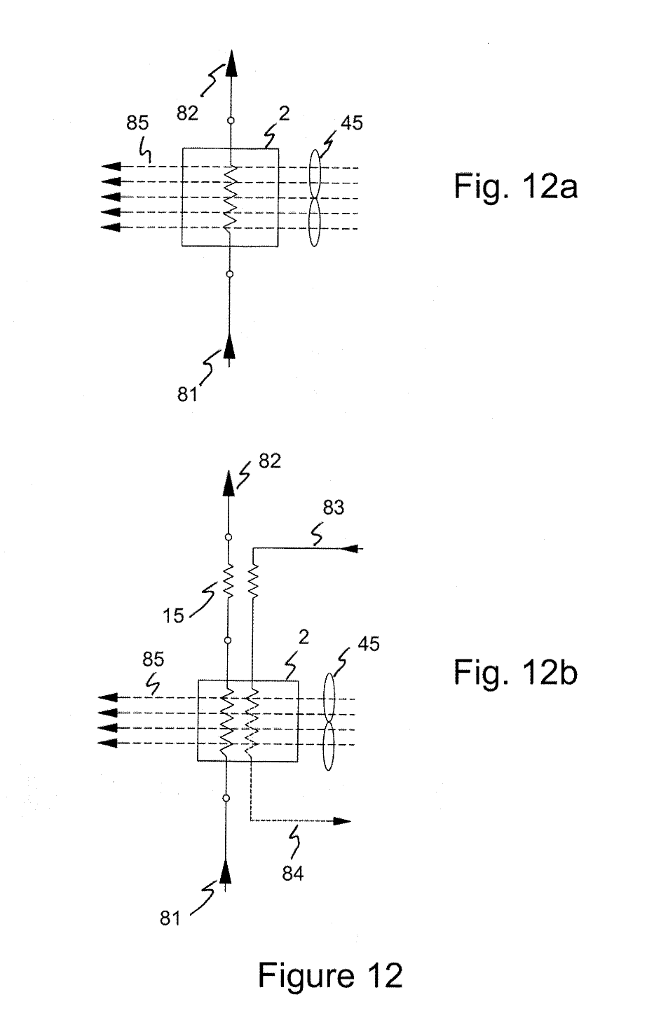

FIG. 12 is a schematic comparison of a base case intercooler with an optimized combination of smaller intercooler and further cooling downstream of the intercooler. This integrated intercooler/vaporizer provides the most thermodynamic benefit, by cooling the compressed air at the inlet to the high pressure compressor below the temperature otherwise obtainable with a conventional air-to-air intercooler, and provides some size reduction of intercooler 2.

FIG. 12a illustrates a standard cross flow air-air intercooler. In the present example, the inlet air 81 to intercooler 2 enters at typically about 416 K (˜290 F). The cross flow cooling air 85 driven by fan 45 enters intercooler 2 typically at about 298 K (˜59 F). The outlet air 82 from intercooler 2, as in FIG. 10a, is typically at about 292 K (˜66 F). The heat exchange process occurs at approximately constant pressure.

In FIG. 12b, a somewhat smaller intercooler 2 is used along with a somewhat larger fuel vaporizer 15 which is added downstream of intercooler 2. In this case, the inlet air 81 to intercooler 2 enters at typically about 416 K (˜290 F). The cross flow cooling air 85 driven by fan 45 enters typically at about 298 K (˜59 F). The outlet air 82 from the optimized intercooler 2 is typically at about 292 K (˜66 F). The main air flow is further cooled by fuel vaporizer 15 to 281 K (˜45 F) by the liquid natural gas stream 83 which enters fuel vaporizer 15 at a temperature in the range of about 130 K to about 150 K and exits fuel vaporizer 15 as a vapor at a temperature of about 410 K (˜278 F). This vapor can then be injected into the engine's combustor (not shown). Both intercooler and fuel vaporizer processes occur at approximately constant pressure.

The above examples were analyzed based on a gas turbine engine with a maximum shaft output power of about 375 kW. As can be appreciated, the inventions disclosed herein can be applied to larger or smaller gas turbine engines that use LNG as their main fuel.

The results of the configurations described in FIGS. 10, 11 and 12 are summarized in the following table.

TABLE VII

| | Intercooler | Intercooler | Vaporizer | Inter- |
|---|---|---|---|---|
| | Input | Output | Output | cooler |
| | Temperature | Temperature | temperature | Effec- |
| | (K) | (K) | (K) | tiveness |
| Base Case | 416 | 292 | NA | 0.9182 |
| Intercooler | | | | |
| Only | | | | |
| Base Case | 416 | 292 | 281 | 0.9182 |
| Intercooler + | | | | |
| Vaporizer | | | | |
| Small | 416 | 303 | 292 | 0.8792 |
| Intercooler + | | | | |
| Vaporizer | | | | |
| Combined | 416 | 292 | 281 | |
| Intercooler + | | | | |
| Vaporizer | | | | |

### Other Sources of Engine Heat for Heating Fuel

In the above examples, fuel is heated by utilizing the waste heat discarded by the intercooler (FIG. 9), the waste heat exiting the exhaust pipe (FIG. 6) and by direct injection of the fuel into the working fluid (FIG. 8). In the case of LNG fuel, the fuel can be heated by cooling the engine inlet air (FIG. 7). There are other sources of waste heat in a gas turbine engine such as radiated heat from the combustor, recuperator and ducts connecting the various components, for example. This radiated heat can be used to provide some heating for the engine's fuel by using an appropriate heat exchanger or heat jacket.

The disclosures presented herein may be used on gas turbine engines used in vehicles or in gas turbine engines used in stationary applications such as, for example, power generation and gas compression.

The exemplary systems and methods of this disclosure have been described in relation to preferred aspects, embodiments, and configurations. Modifications and alterations will occur to others upon a reading and understanding of the preceding detailed description. It is intended that the disclosure be construed as including all such modifications and alterations insofar as they come within the scope of the appended claims or the equivalents thereof. To avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

A number of variations and modifications of the inventions can be used. As will be appreciated, it would be possible to provide for some features of the inventions without providing others.

The present invention, in various embodiments, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter

What is claimed is:

1. An apparatus, comprising:
one or more turbo-compressor spools in fluid communication with one another, each of the one or more turbo-compressor spools comprising a compressor in mechanical communication with a turbine;
a fuel source comprising a fuel;
one of a heat exchanger and heat jacket to transfer heat from a fluid associated with operation of the one or more turbo-compressor spools to a portion of the fuel to substantially heat the portion of the fuel to form a heated fuel; and
a combustor operable to combust the heated fuel.

2. The apparatus of claim 1, wherein the one of a heat exchanger and heat jacket transfers heat from a working fluid exiting the one or more turbo-compressor spools, to the portion of the fuel.

3. The apparatus of claim 1, wherein the one of a heat exchanger and heat jacket transfers heat from a working fluid exiting a recuperator downstream of a free power turbine; to the portion of the fuel.

4. The apparatus of claim 1, wherein the one of a heat exchanger and heat jacket transfers heat from a working fluid entering the engine inlet duct, to the portion of the fuel.

5. The apparatus of claim 2, wherein the one of a heat exchanger and heat jacket is an intercooler positioned in a fluid path between any two of the one or more turbo-compressor spools.

6. The apparatus of claim 3, wherein the one of a heat exchanger and heat jacket is in thermal contact with the working fluid passing through the engine exhaust pipe.

7. The apparatus of claim 4, wherein the one of a heat exchanger and heat jacket is in thermal contact with the working fluid passing through the engine inlet duct.

8. The apparatus of claim 1, wherein the heat exchanger is a recuperator, wherein the working fluid is an output gas of a free power turbine.

9. The apparatus of claim 1, wherein the one of a heat exchanger and heat jacket is positioned in a fluid path between the compressors in first and second turbo-compressor spools.

10. The apparatus of claim 1, wherein the one of a heat exchanger and heat jacket is positioned in a fluid path between the turbines in first and second turbo-compressor spools.

11. The apparatus of claim 1, wherein the one of a heat exchanger and heat jacket is positioned in a fluid path between the turbine in the first turbo-compressor spool and a free power turbine.

12. The apparatus of claim 1, wherein the one of a heat exchanger and heat jacket is positioned in a fluid path between a compressor and turbine of the second turbo-compressor spool.

13. The apparatus of claim 1, wherein the fuel provided by the fuel source is at least one of liquid natural gas, liquid natural gas vapor, gaseous methane, diesel, kerosene, gasoline, bio-diesel, ethanol, methanol, butanol, ammonia, and hydrogen.

14. The apparatus of claim 1, wherein the one of a heat exchanger and heat jacket transfers to the fuel portion heat from at least one of an engine inlet duct, the one or more turbo-compressor spools and an engine exhaust pipe.

15. A method, comprising:
compressing, by a compressor in a first turbo-compressor spool, an inlet gas to form a first working fluid;
compressing, by a compressor in a second turbo-compressor spool, the first working fluid to form a second working fluid;
substantially heating a fuel comprising at least one of liquid natural gas, liquid natural gas vapor, gaseous methane, diesel, kerosene, gasoline, bio-diesel, methanol, ethanol, butanol, ammonia, and hydrogen to form a heated gas;
combusting the fuel and the second working fluid to form a combusted working fluid;
driving, by the combusted working fluid, a turbine of the second turbo-compressor spool; and
driving, by the combusted working fluid, a turbine of the first turbo-compressor spool.

16. The method of claim 15, wherein the fuel is substantially heated by one of a heat exchanger and heat jacket, the one of a heat exchanger and heat jacket transferring heat from at least one of the inlet gas, the first working fluid, the second working fluid and the combusted working fluid.

17. The method of claim 15, wherein the fuel is substantially heated by heat transferred from the combusted working fluid after the combusted working fluid has exited a free power turbine.

18. The method of claim 15, wherein the fuel is substantially heated by heat transferred from the combusted working fluid after the combusted working fluid has exited a recuperator.

19. The method of claim 15, wherein the fuel is substantially heated by one of a heat exchanger and heat jacket, the one of a heat exchanger and heat jacket transferring heat from an inlet gas to the compressor in the first turbo-compressor spool.

20. The method of claim 16, wherein the heat exchanger is an intercooler positioned in a fluid path between the first and second turbo-compressor spools.

21. The method of claim 16, wherein the one of a heat exchanger and heat jacket is in thermal contact with the working fluid passing through an engine exhaust pipe.

22. The method of claim 16, wherein the one of a heat exchanger and heat jacket is in thermal contact with the working fluid passing through an engine inlet duct.

23. The method of claim 12, wherein the fuel is LNG and the LNG is substantially vaporized by introduction of the LNG into the first working fluid downstream of an intercooler and upstream of the compressor in the second turbo-compressor spool.

24. An apparatus, comprising:
at least first and second turbo-compressor spools in fluid communication with one another, each of the at least first and second turbo-compressor spools comprising a compressor in mechanical communication with a turbine;
a fuel source comprising at least one of liquid natural gas, liquid natural gas vapor, gaseous methane, diesel, kerosene, gasoline, bio-diesel, methanol, ethanol, butanol, ammonia, and hydrogen;
a fuel path to introduce fuel into a working fluid path to substantially heat the fuel to form a gas; and
a combustor operable to combust the gas.

25. The apparatus of claim 24, wherein a section of the working fluid path is positioned between a compressor of the first turbo-compressor spool and a compressor of the second turbo-compressor spool and wherein the fuel fluid path fluidly connects with the working fluid path.

26. The apparatus of claim 25 wherein the fuel is LNG at a temperature where the LNG is a liquid.

27. The apparatus of claim 24, wherein a section of the working fluid path is positioned between a compressor of the second turbo-compressor spool and a turbine of the second turbo-compressor spool and wherein the fuel fluid path fluidly connects with the working fluid path and wherein the fuel is contacted with the working fluid upstream of the combustor.

28. The apparatus of claim 25 wherein the fuel is LNG at a temperature where the LNG is a liquid and wherein the fuel is vaporized when contacted with the working fluid.
